(19) United States
(12) Patent Application Publication
(10) Pub. No.: US 2003/0158614 A1
(43) Pub. Date: Aug. 21, 2003

(54) Audio system for vehicle with battery-backed storage

(76) Inventors: Joseph T. Friel, Ardmore, PA (US); Andrew P. Weir, West Chester, PA (US); Joseph J. Cotellese, Chalfont, PA (US); Alan J. MacDonald, Malvern, PA (US); J. William Mauchly, Berwyn, PA (US); David W. Sowa, Exton, PA (US); Michael A. Arnao, Audubon, PA (US)

Correspondence Address: Woodcock Washburn LLP, One Liberty Place - 46th Floor, Philadelphia, PA, 19103, US

(21) Appl. No.: 10/079,011

(22) Filed: Feb. 18, 2002

(51) Int. Cl. G06F 17/00; H04B 1/00

(52) U.S. Cl. 700/94; 381/86; 455/345

(57) ABSTRACT

An audio system is mounted in a vehicle and provides playback of digital audio content stored in semiconductor DRAM. Power from the vehicle's battery is constantly applied to the DRAM to retain information even when the vehicle is not operating. The audio content may be acquired by the recording of broadcast radio programs, by streaming content from a wireless Internet connection, from a CD, and/or from a wireless link to a computer. An updated playlist may be provided to the DRAM on a periodic basis or manually under user control.

### BACKGROUND OF THE INVENTION

1. Field of the Invention

The present invention relates generally to an audio playback system, and more particularly, to an audio playback system using volatile memory that draws power from the vehicle's battery, even when the vehicle is not in use, thereby allowing for the use of, e.g., inexpensive DRAM instead of a relatively expensive nonvolatile storage device.

2. Description of the Prior Art

Audio is the main source of entertainment and information inside a motor vehicle, and variety of content is always important. The two main sources of this audio are radio broadcasts and pre-recorded removable media, such as CDs. Recently, however, PC users have been using the Internet to procure digital audio content, and this material is collected, in a compressed form, on their computer's hard-disk. It would be desirable to also have access to this digital content while driving a car.

The existing methods to provide digital audio content to a vehicle have disadvantages. Today the most sensible way to make a portable copy of a file on a PC is to “burn” a writable CD with the audio content and to carry the CD to the car. Besides the cost of the CD writing apparatus and the car CD player, this solution demands the time and trouble to write the CD, to carry the CD to the car, and to store, organize, and handle a multitude of CDs in the car.

The multiple CD changer is a product that addresses the desire to access more music without handling CD disks. These devices are usually relegated to the truck of a vehicle because of their size. This location creates even more inconvenience when the user wishes to add a new CD to the small collection physically present in the CD changer.

A better way to get digital audio content from the PC to inside a vehicle is to use a wireless transmission while the vehicle is parked near the PC. This download can be done at a time when the computer is not otherwise in use and the car is nearby, as in the SimpleAuto™ system described at http://simpledevices.com. In such a system, there must be a mass-storage device inside the car, for a removable medium is inappropriate for this function. The ideal storage device in this application would be non-volatile, non-removable, and low cost. A hard disk is the obvious choice, except that it is a relatively expensive device. Flash memory is also appropriate, yet it too is expensive compared to Dynamic Random Access Memory (DRAM). However, DRAM is not an obvious choice for permanent digital audio storage for use with such a device because it is volatile and will lose its contents when power is not present. Computer systems that use DRAM use it for temporary storage and typically have another non-volatile medium that is used as the permanent storage.

U.S. Pat. No. 5,633,837 (Gantt, May 27, 1997) discloses an automobile radio recording system that uses solid state memory (DRAM). However, in this case the memory is used as temporary storage. Any information that is to be saved permanently is selectively transferred to tape.

Other audio products that are intended for the automobile use hard disks for permanent storage. An example is the SSI Neo 35 Car Jukebox, which is described at: (http://ssiamerica.com/products/neo35/). Some of these devices, which are often based on convention personal computer architecture, include DRAM. Again, the solid state memory (DRAM) is used only as volatile temporary memory, and it is only powered when the system is in operation. The use of such a hard-disk-based MP3 player is hindered by the method of acquiring content from a PC in that the hard-disk must be physically carried to a place where a short cable can connect it to the PC.

On the other hand, U.S. Pat. No. 5,671,195 (Lee, Sep. 23, 1997) discloses an audio system programmable for recording pre-selected audio broadcasts. The recording function described is very much like a VCR except that it records audio only. The description does not explain whether the device works in a vehicle or the type of memory used for recording. Rather, a recording-and-reproducing means is required for the audio, and a power supply system is required that can be turned on and off (manually and automatically). The described embodiment requires the user to manually enter a set of programming data for each radio segment that is to be recorded.

U.S. Pat. No. 5,742,893 (Frank, Apr. 21, 1998) describes a music-playing system for a motor vehicle in which radio is used to pipe music into the vehicle but the music storage library is outside the car. In other words, the music is “streamed” into the car (from a home PC, presumably). No mass storage medium is required or suggested for use inside the car. The disclosed system relies on the existence of reliable high-bandwidth Internet access while the car is moving.

U.S. Pat. No. 5,732,324 (Rieger, III, Mar. 24, 1998) describes a digital radio system for transferring an audio program to a passing vehicle using short-range radio. In this system, the receiving device in the car stores the transmitted data and then plays it back as audio. There is no facility provided for retaining the contents of the broadcast after the vehicle is turned off. The disclosed system is focused on delivering short pieces of information, not on providing a library of audio entertainment.

As will be explained in more detail below, an audio device is desired for a vehicle that permits storage and playback of digital audio in a compact, reliable, and cost-effective system. One way this is accomplished is by using volatile memory that is powered by the vehicle's battery but does not drain the battery. In this connection, it is known from, for example, U.S. Pat. No. 6,249,106 (Turner, et al., Jun. 19, 2001) to prevent a battery-backed device from draining the car battery. However, applicant is not aware of a battery protection circuit that only controls power to a specific device, not the whole vehicle, for a device that purposefully uses battery power whether or not the vehicle is in operation. As will also be explained below, the prior art also does not disclose the use of a microprocessor that selectively powers parts of the audio device and utilizes low-power modes, rather than a simple power switch as described by Turner.

An audio device is desired that can acquire digital audio from a variety of sources. All such audio should be stored in a common memory device for convenient access from within the vehicle while traveling. The present invention is designed to meet these needs in the art.

### SUMMARY OF THE INVENTION

The present invention meets the needs in the art noted above by providing an audio system for a vehicle that can provide digital file playback from DRAM, without the use of a hard disk or flash memory. The present invention also provides an audio system for a vehicle that can acquire audio content in a number of ways, including the recording of radio broadcasts, downloading from the Internet, copying digitally from a CD, or downloading from a nearby computer. In accordance with the invention, a computer link to an in-vehicle audio device may be used to manage, program, and automatically update the audio device.

The audio system of the invention comprises four main components: an audio memory, a digital audio playback device, an audio acquisition device, and a power supply. The digital audio playback device may be a conventional device for playing back stored digital audio, and the power supply is preferably conventional except that means are provided for determining if the vehicle battery is being drained below a threshold.

Since the audio stored digitally in memory is typically compressed by an audio compression algorithm such as MPEG-2, Layer III (MP3), the digital audio playback device is preferably capable of decompressing the data for playback. The audio acquisition device, on the other hand, is preferably capable of recording audio data from analog public radio broadcast and digitally compressing it. Likewise, it is preferably capable of compressing the digital PCM data from a CD, and may also acquire audio data from a private wireless connection to a PC. The audio also may be recorded from a digital broadcast and downloaded from the Internet through a wireless Internet service provider.

The audio memory is DRAM or one of its variants, such as SDRAM. The device is consistently powered by a connection to the vehicle's electrical system, even when the ignition switch is turned off. The device can selectively control the power state of the DRAM so that it is either in a low-power state or a fill-power state. Even in the low-power state the DRAM will still retain its memory contents. The penalty for using DRAM in this application is that it constantly drains power from the battery when the vehicle is not in use. However, with modem DRAM technology this drain is not significant. In a preferred embodiment, a power monitor is added to the power supply in the vehicle to shut off the device and thus prevent the battery from being drained below a certain level.

The present invention improves on the current state of the art by using DRAM instead of a hard-disk drive for long-term audio storage. A typical hard disk takes more space, generates more heat, and is more unreliable than solid state memory. A moderate amount of DRAM (128 Mbyte) is much less expensive than a hard-drive. DRAM is also less expensive than a comparable amount of flash memory. Thus the present invention allows the creation of lower cost digital audio devices. It can be applied to a variety of different digital audio devices, including, but not limited to, CD jukeboxes and radio recorders.

The present invention also improves on prior art devices that record radio broadcasts. As noted above, the system described in U.S. Pat. No. 5,633,837 records radio into DRAM temporarily but requires a tape recorder to make a copy that endures after the engine is turned off. The present invention makes the tape recorder unnecessary. U.S. Pat. No. 5,732,324 describes a system which can receive short bursts of radio while the car is in motion, buffer them in RAM, and then play them back. The present invention would expand the applications of this localized broadcast by adding non-volatile storage at little extra cost.

As noted above, techniques are known for programming a radio-recorder to record certain broadcasts at certain times. The user interface in such systems is similar to that used to program a VCR to record. The present invention offers a more friendly and useful way of interacting with the device. By including a wireless link to a personal computer, the user can take advantage of a graphical user interface (GUI) and an electronic program guide (EPG) to aid in this task.

The present invention employs DRAM, not a hard-disk; provides for several different audio acquisition paths into the same digital storage, and uses the radio link to a PC not just to acquire audio but also to program the in-car radio recorder. Various different audio acquisition means may be used in combination to feed a single digital storage unit. The first advantage of this combination is the reduced cost of a shared resource over redundant ones. The cost of adding a second or third acquisition means is thus minimized. But in their combination these input methods offer a new advantage in that information that is not available via one method of acquisition is often available from another. In particular, meta-data, that is, information about the audio content, which is not available from radio or CDs, is accessible via the Internet.

The techniques of the invention are not limited to use with a vehicle stereo system but may also be used to provide digital audio data to a home stereo system for storage and playback. These and other advantages will be apparent from the following detailed description of the invention.

### BRIEF DESCRIPTION OF THE DRAWINGS

An audio playback system and method in accordance with the invention is further described below with reference to the accompanying drawings, in which:

FIG. 1 is a diagram of the audio system and its connections to various audio sources.

FIG. 2 is a diagram of the first embodiment of the invention, implemented as an integrated head unit, and its associated connections.

FIG. 3 is a diagram of the second embodiment of the invention, implemented as an add-on for an existing car stereo.

FIG. 4 is a block diagram of the audio system components in accordance with a preferred embodiment of the invention.

FIG. 5 is a detailed diagram of the audio system components of FIG. 4.

FIG. 6 is a flow chart of the program in the PC for providing audio content to the audio storage device in accordance with the invention.

FIG. 7 is a flow chart for the programming of the microprocessor in the head-unit of the audio playback device of the invention.

### DETAILED DESCRIPTION OF THE PREFERRED EMBODIMENT

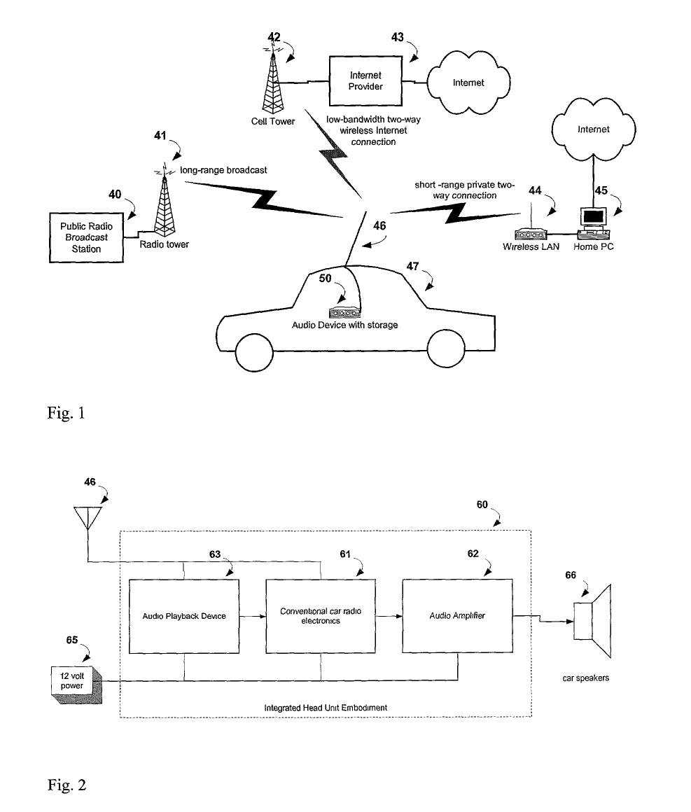

FIG. 1 illustrates the audio system of the invention and its connection to various audio sources. As illustrated, the audio device 50 of the invention is mounted within a vehicle 47 and configured to receive digital audio data via antenna 46 from one or more audio sources, including audio data broadcast over analog or digital AM or FM radio broadcast channels from a radio tower 41 connected to a public radio broadcast station 40, audio data transmitted over a wireless Internet cell network connection from a cell tower 42 connected to the Internet via Internet Service provider 43 so as to provide mobile Internet access, and audio data transmitted over a short-range private two-way radio connection from, e.g., a nearby wireless LAN 44 connected to a computer 45 in the user's home. Any one of these data input sources is sufficient to enjoy to benefit of the low-cost digital storage and to provide desirable audio content to the user in accordance with the invention. Of course, other techniques for transmitting audio data may be used such as direct satellite transmission (e.g., digital satellite radio), and the like. Also, the audio data could be loaded into the audio device 50 in a conventional manner by inserting a suitable memory storage device such as a compact disk for reading/downloading of stored audio data.

In a first embodiment of the invention, the audio device 50 is incorporated into a car stereo. The integrated head-unit 60 is mounted in the dashboard like a conventional car radio or cassette player. As shown in FIG. 2, this head-unit 60 includes conventional car radio electronics 61 and audio amplifier circuitry 62 to provide the functionality of a conventional car radio, as well as an audio acquisition, storage and playback device 63 having the capability of acquiring and playing back stored digital audio in accordance with the invention. As will be explained below, the audio acquisition, storage and playback device 63 includes audio acquisition means and digital storage for storing the acquired data as well as playback circuitry. In operation, the device 63 simply provides an audio output that becomes an input to the conventional car radio electronics 61. The audio acquisition and/or the digital storage portion of device 63 (described in more detail below) may be located elsewhere in the vehicle, as desired.

As shown in FIG. 2, the head unit 60 is connected to the 12-volt power system 65 of the vehicle. As will be explained in more detail below, the connection with the 12-volt power system 65 is an always-on connection, to be differentiated from a “switched-power” connection that would not be powered when the car ignition is off. In other words, power is always supplied to the system components.

The output of the audio playback device 63 is a stereo analog audio output at line level, which becomes a line input to the conventional car radio electronics 61. This block provides at least a volume control and tone controls to the signal before it is amplified by audio amplifier 62 and sent to speaker(s) 66 mounted in the vehicle. As shown, the head unit 60 is also connected to the antenna 46 for receipt of broadcast audio. Thus, those skilled in the art will appreciate that the head unit 60 of the invention may be installed as easily as a conventional car radio.

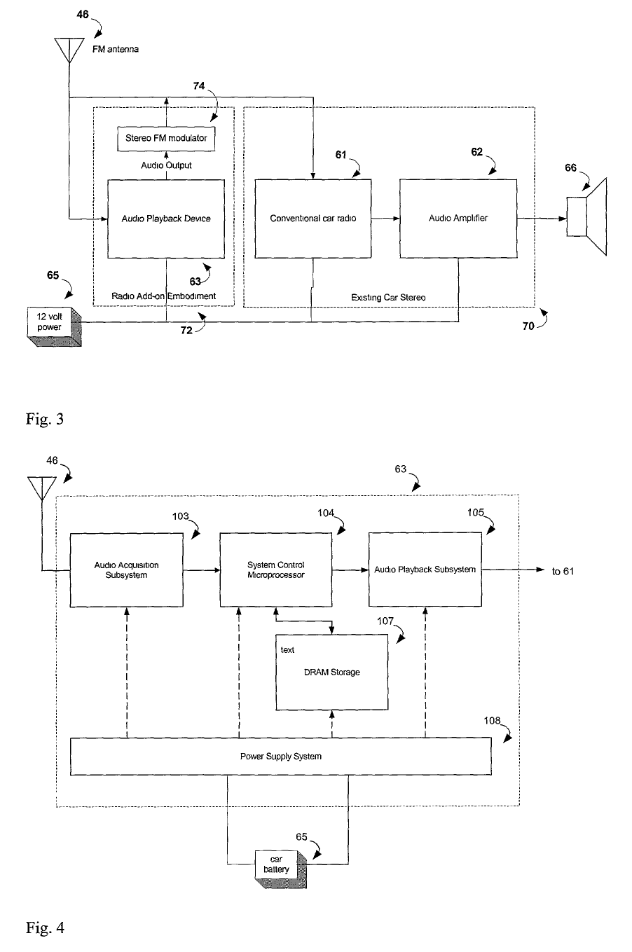

In a second embodiment of the invention, the audio device 50 is not incorporated into a car stereo but is instead provided as an add-on to a conventional car radio. As shown in FIG. 3, the existing car radio 70 including conventional car radio electronics 61 and audio amplifier circuitry 62 is, e.g., mounted in the dashboard of the vehicle to provide the functionality of a conventional car radio. In this embodiment, audio playback device 72 is provided as an add-on device having the capability of acquiring and playing back stored digital audio in accordance with the invention. As shown, since the devices are not integrated, the audio output of the audio playback device 63 is modulated by stereo FM modulator 74 and applied as an input on an unoccupied FM channel to the conventional car radio 61 for playback. Such a method is commonly used for after-market CD players. In this embodiment, the components are also connected to the 12-volt power system 65 of the vehicle and maintained in an always-on connection.

Those skilled in the art will appreciate that the embodiment of FIG. 3 has the advantages of low cost and simplicity of installation; however, the embodiment of FIG. 3 has the disadvantage that two user-interfaces are necessary—one for the pre-existing radio and one for the new audio playback device of the invention.

FIG. 4 is a block diagram of the components of the audio playback device 63 that, as noted above, may be mounted in the vehicle dash, mounted in the vehicle's trunk, or mounted in some other inconspicuous place. As illustrated, the audio playback device 63 includes an audio acquisition subsystem 103 that receives, e.g., AM/FM analog/digital radio data, audio data from the user's PC 45 via short-range radio, and/or audio data from the Internet via a wireless Internet connection at antenna 46. A system control microprocessor 104 controls audio data storage and recall based on commands from the user, and the read data is processed (decompressed and the like) by audio playback subsystem 105 for playback to the user via the vehicle's radio. DRAM storage 107 stores the audio data for recall and playback.

As will be explained in more detail below, power supply system 108 regulates the application of battery power to the system components from car battery 65 so that an always-on connection is provided.

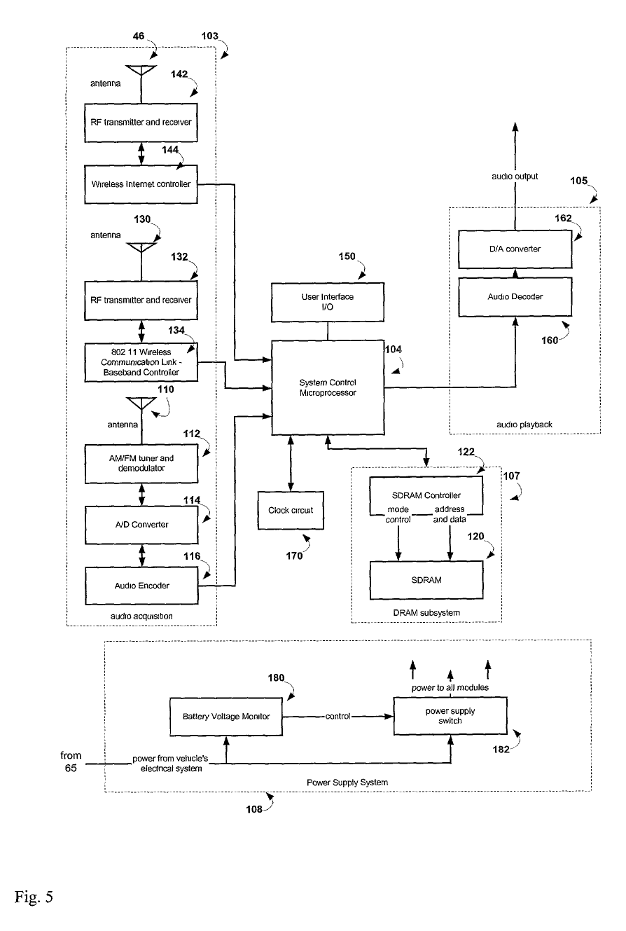

FIG. 5 illustrates the audio system components of FIG. 4 in more detail. As shown, the preferred embodiment of the audio acquisition subsystem 103 collects data from three different audio data sources: an AM/FM link, a PC link, and a mobile Internet link (compare FIG. 1). As shown in FIG. 5, the audio acquisition subsystem 103 includes a radio receiver comprising AM/FM antenna 110, AM/FM tuner and demodulator 112, A/D converter 114, and audio encoder 116. The audio acquisition subsystem 103 thus can receive AM and FM broadcasts and may be tuned and operated automatically by the device even when the car is not in use. Preferably, programming means are provided by which the user can specify the parameters that allow the audio playback device 63 to record a particular radio program. In operation, the AM/FM radio receiving unit receives broadcast signals from AM or FM transmissions at antenna 110 at a frequency selected by AM/FM tuner 112 and demodulates the received signal to produce analog audio signals which are presented to the analog-to-digital (A/D) converter 114. The sampled and digitized audio is then compressed by the audio encoder circuit 116 and stored, e.g., in DRAM storage 107. This compression may be of any type, such as MPEG-2 Layer III, which is commonly called MP3, or a simpler compression such as ADPCM. The compressed audio data is then taken by the system control microprocessor 104. Of course, the compression may be performed inside the system control microprocessor 104 rather than by a separate physical component.

The recording process occurs selectively. Not everything that comes from the AM/FM tuner and demodulator 112 is recorded. When an audio signal is to be recorded, it is transferred to the DRAM storage 107 where it is loaded into, e.g., SDRAM 120 by SDRAM controller 122. The microprocessor 104 keeps track of multiple recordings in the DRAM storage 107, and a program loaded on microprocessor 104 manages a list of the recordings, the list containing the location of the various audio segments. One recording method it may use is a circular buffer, in which it is writing over the oldest data that has been recorded. Recording audio data into DRAM in this fashion is a well-understood and common practice.

The audio acquisition subsystem 103 may also accept audio data via a two-way radio link to a computer (PC). As shown in FIG. 5, both the audio acquisition subsystem 103 and the computer are preferably equipped with a short-range radio device that is capable of two-way communication. In other words, antenna 130 transmits/receives short range radio broadcasts using RF transmitter/receiver 132. The communications protocol may be IEEE 802.11b, HomeRF or a simpler protocol provided by 802.11 wireless communication link baseband controller 134. Preferably, the communications is digital and should provide guaranteed delivery of digital data by retransmitting lost data packets. The range of the two-way radio link should be at least 100 feet; 500 feet or more so as to allow placement of the receiver in the user's vehicle at a safe transmission distance from the user's home. In other words, it is intended that the PC 45 be located in a building, for example the user's home, and for the vehicle to be parked nearby during some part of the day or night. The computer can be powered but unattended during the time communication takes place.

The audio acquisition subsystem may also accept audio data received by antenna 140 via a direct wireless Internet connection. Today, the cell phone network provides Internet access, albeit with limited bandwidth. While such a low-bandwidth connection may not be usable to stream audio data for real-time playback, it could trickle data to the onboard memory, to be played back when the file transfer is complete. Those skilled in the art will also appreciate that broadband Internet access may be made available in a moving car using known technologies. In this embodiment, the audio data from the Internet is provided to RF transmitter and receiver 142 and to a wireless Internet controller 144 for processing by system control microprocessor 104 and storage in SDRAM 120.

The user I/O interface 150 to the system should use a method that can be operated easily by the driver of the vehicle. While the details of the user I/O interface 150 are beyond the scope of this invention, those skilled in the art will appreciate that a suitable user I/O interface 150 includes a group of labeled buttons which together constitute an input device. As per convention, there are “transport” controls that cause the audio to play, stop, fast-forward, and rewind. There are also selection buttons by which the user can choose between a plurality of recorded audio programs or musical pieces.

In the preferred embodiment, the user I/O interface 150 includes a graphics display screen (not shown) with enough resolution to show several lines of text. The display screen shows a list of items, and the user uses up and down arrow buttons to navigate within the list. A select button and an “exit” button are used in a conventional manner to travel within a hierarchical tree organization of menu items.

The audio items that are contained in the SDRAM 120 and available for playback are preferably grouped into categories. The definition of the categories themselves may be user-definable, and the PC link provides a rich text-editing environment as necessary. Audio content may be organized by its source, for example, and the list may contain categories like “recorded radio,” “internet radio,” and “MP3.” Music may also be divided into groups according to musical style, artist, and the like.

Commonly accessed audio programs also may be assigned to a particular physical button. Conventional radios typically have 4 to 6 buttons that allow the user to select “presets” which are simple radio frequencies. In the audio playback device of the invention, such preset buttons may be assigned to particular content. Several patents have been granted for various ways of achieving such a “traffic button.” For example, U.S. Pat. No. 5,671,195 describes a radio recorder that is programmed to record, at ten-minute intervals, the traffic report from a public news radio station. (It is a convention of most news radio stations to broadcast traffic reports at fixed times within the hour.) The user interface of the preferred embodiment may thus assign one button to always be “traffic.” The latest recorded traffic report will start playing when this button is pressed.

When playback is engaged by the user I/O interface 150, the microprocessor 104 reads the appropriate audio data from DRAM 120 and feeds it to the audio decoder 160 of the audio playback subsystem 105. The audio decoder 160 decodes the audio data and presents it to the D/A converter 162, which produces analog audio signals from the digital audio signals. The final output of the device is then available to be reproduced by a conventional audio system as described above. More specifically, the analog audio output may be fed into the line inputs of audio amplifiers in audio amplifier 62 and provided to speakers 66 inside the vehicle.

The DRAM storage subsystem 107 is designed to hold several hours of recorded audio material. Compressed audio of reasonable quality will consume about 30 Mbytes per hour. Thus, in the preferred embodiment, the DRAM storage subsystem 107 preferably has a storage capacity of at least 128 Mbytes.

The preferred embodiment of DRAM storage subsystem 107 uses a specialized form of DRAM call synchronous DRAM, or SDRAM. SDRAM is an advanced form of DRAM with some special operation modes, including a low-power self-refresh mode. An SDRAM controller 122 is used between the microprocessor bus and the SDRAM 120. The SDRAM controller 122 is necessary because of the particular access method and timing used to talk to the SDRAM 120.

One of the novel aspects of the system of the invention involves its use of DRAM. Unlike conventional car entertainment systems, the system of the invention must constantly use power to keep the DRAM data intact. The system of the invention does not have its own battery but instead uses the vehicle's battery. Since DRAMs draw very little power, even when the system is left powered overnight the DRAM does not draw enough power from the vehicle battery to adversely affect the battery's performance in the morning. SDRAM is presently preferred for use as the DRAM in such a system since SDRAM has a low-power mode called self-refresh. In this mode, the SDRAM 120 will retain its contents but it cannot be accessed by the microprocessor 104. When the system is operating, that is, it is either receiving or playing audio data, then the SDRAM 120 must be in full power operation. When the system is not in operation, then the system will put itself into a “sleep mode,” in which the SDRAM 120 is put into self-refresh mode by the SDRAM controller 122. Other parts of the system, such as the microprocessor 104, can be completely turned off, or can also be put in low-power mode.

For example, Infineon makes a 64-Mbit Synchronous DRAM part called HYB 39S64400/800CT. The device is designed to comply with all JEDEC standards set for synchronous DRAM products, both electrically and mechanically. The self-refresh operation is supported, and during normal operation, the SDRAM is specified to draw a maximum of 100 mA current. In self-refresh mode, the SDRAM draws only 1 mA current.

Clock circuit 170 is used to activate the recording function at preprogrammed times. It creates a wake-up signal that causes the microprocessor 104 to come to full power and evaluate the next appropriate action. The clock circuit 170 is programmed with a wake-up time interval by the microprocessor 104 before the microprocessor 104 is put in sleep mode.

As shown in FIG. 5, the power supply system 108 includes a battery voltage monitor 180 and a power supply switch 182. The battery voltage monitor 180 is a protection circuit for the system battery 65. In the event that the car has been left for many days, or the battery is too weak, it will be desirable to prevent draining of the battery. In such case, the battery voltage monitor 180 will trigger the power supply 65 to remove all power from the entire audio system (except the battery voltage monitor 180.) The battery voltage monitor 180 continues to monitor the voltage, so that it can re-power the audio system when power is available again. Alternately, the power supply switch 182 can be turned back on when “switched power” is detected. Switched power is 12-volt power that is only available when the ignition switch is turned on.

In the event that the system does turn its own power off, eventually the car is started and the battery recharged. At this point, the audio playback device 63 does not have any data in DRAM (it was lost when the power was removed). Thus, the audio circuitry will attempt to reconnect with the nearby PC, if there is one, and reload its audio content. For the case of a radio-recorder without a PC link, it would be preferred that the programming parameters are kept in a small bit of flash memory, so they would not need to be re-entered by the user.

As explained with respect to FIG. 1, the head-unit 60 can receive radio transmissions from several different sources. Preferably, head unit 60 may receive audio data from several such data sources to increase the versatility of the system. In accordance with the invention, all of these input systems share a common storage unit in audio playback device 63, a common playback system, and a common user interface. However, those skilled in the art will appreciate that it is not necessary to include all such data input sources in the invention. Any one of these data input sources is sufficient to enjoy the benefit of the low-cost digital storage and to provide desirable audio content to the user.

The usage of the audio system of the invention typically involves following these steps:

1. The user would specify the audio content that the user desires to be acquired.

2. The audio unit acquires, by one or more of the audio acquisition channels, the desired audio content. This may occur overnight when the unit is not attended and the car is not in use.

3. The user drives the vehicle, typically to and from work, and during driving he/she activates the audio playback of one or more audio files, by pushing buttons on the front panel of the dash unit 60 or 72.

4. The audio unit may continue to acquire new audio content periodically, depending on the specification supplied in step 1. At any time the user can repeat step 1 resulting in a different selection of audio content delivered to the vehicle.

Specification of content, as in step 1 above, can be accomplished in at least two different ways. Either it can be done from the car, by using the user I/O interface 150 of the audio unit, or it can be done from a computer, which can transfer the information to the audio unit over a wireless digital link. The nature of the content specification, as in step 1 above, will differ depending on the type of audio material desired and the source. There are several types of audio files that would be collected:

a. Recording of scheduled broadcasts on public radio stations;

b. Recordings of individual pieces of music, typically in MP3 format;

c. Pre-recorded audio programs which can be streamed from the Internet.

For content of the first type, the specification necessary to receive such content is identical to the programming information used to record television shows on a VCR. These parameters are the band (AM or FM), the station frequency to be tuned to, the time and date of the broadcast, and the duration of the broadcast. The system acts, then, like a VCR, wherein it records the radio program, unassisted, and stores it in memory for later playback. For content of the second type, individual songs or pieces of music, the desired files probably reside on the hard disk of the user's personal computer. Such a music library may contain hundreds of songs, and this library may be larger than the storage capacity of the system's DRAM. In this case, the user may specify that a different subset of the library is downloaded to the audio unit. Such downloading could be performed each evening or at some other period interval, as desired by the user. For content of the third type, audio that is streamed over the Internet, the user may specify specific URLs that will locate the desired audio. The audio can be streamed to the user's PC, where it is collected as a file and converted to a suitable format for transfer to the audio unit. On the other hand, streaming content could be sent directly, via the cell phone network, to the car while in motion. In this case, the Internet connection could also be used to supply a menu of choices of audio content available.

Combining the radio recorder function with the PC link function in accordance with the invention provides an interesting benefit to the user. While a radio recorder in a vehicle is useful, it is hampered by the necessity of entering detailed programming information. The PC link allows one to use the rich interface of the PC, with its keyboard, mouse, and graphics screen, to select radio shows from an online programming guide. The programming information would then be downloaded to the audio device in the vehicle and be readily available to the user.

The user's PC thus may contain the audio data that is to be transferred to the audio system of the invention. The user's PC may take the role of the master by periodically trying to communicate with the audio system. The audio system will periodically monitor the radio airwaves in search of a connection with the PC. When the vehicle comes within range of the user's PC, or a transmission node in communication with the user's PC, the audio system of the invention will detect the PC's transmission and acknowledge it with a return transmission. In this way, the two parts set up a communications link whenever they are in proximity of each other. Once a communication path is established, the user's PC is given control over the contents of the digital storage in the audio system. It will download digital audio files in compressed form and will download information that describes the digital audio files and how they are organized. The user's PC will download control information that determines how the audio system's user interface will operate. In short, the user's PC will allow the user, through the computer and through the radio link, to control the contents and configuration of the audio device.

In the preferred embodiment, the user's PC will be programmed to update the audio device periodically, such as every day. Every day the user's PC will create a new list of audio files that are to be sent to the audio device. This list may vary because of a random file choice, or because the user has set up a weekly schedule which rotates different audio content through the device.

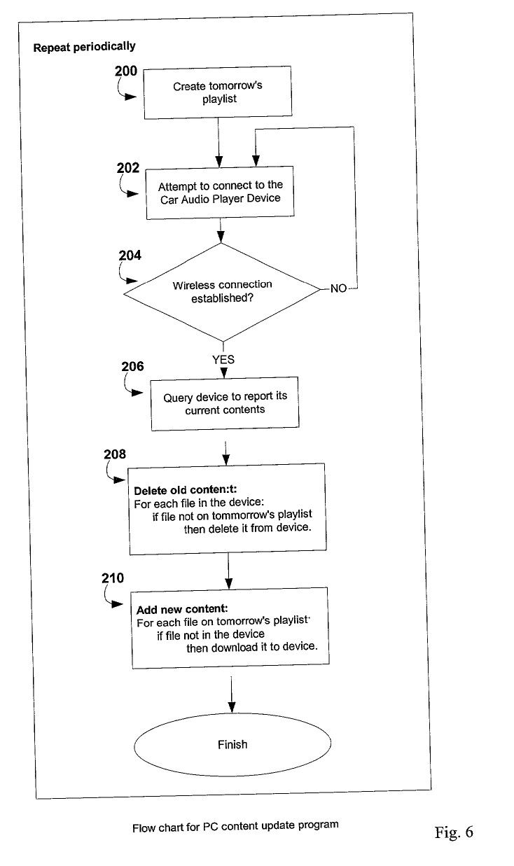

For example, FIG. 6 illustrates a flow chart of the audio content update program on the user's PC. The audio content update program includes an interface that permits the user to create a playlist at step 200 by selecting audio content (MP3 files, etc.) stored on the user's PC. Of course, the user may select audio content from different genres, may select individual songs, entire albums, and the like. The audio content update program may then attempt at step 202 to connect to the vehicle audio player of the invention to upload the playlist. This attempt may be initiated manually by the user or be programmed to occur at one or more designated times during the day, such as in the middle of the night while the vehicle is parked in the driveway and the user is asleep.

At step 204, it is determined whether a wireless connection (e.g., IEEE 802.11) is established and, if not, another attempt to connect is made. Once a connection is established at step 204, the audio device in the vehicle is queried at step 206 to get a report of its current contents. Then, at step 208, the audio device is instructed to delete all content not on the new playlist. Finally, at step 210, the new audio content is downloaded to the audio device. As noted above, this process preferably occurs either at a time initiated by the user or periodically at a time designated by the user or the audio content update program.

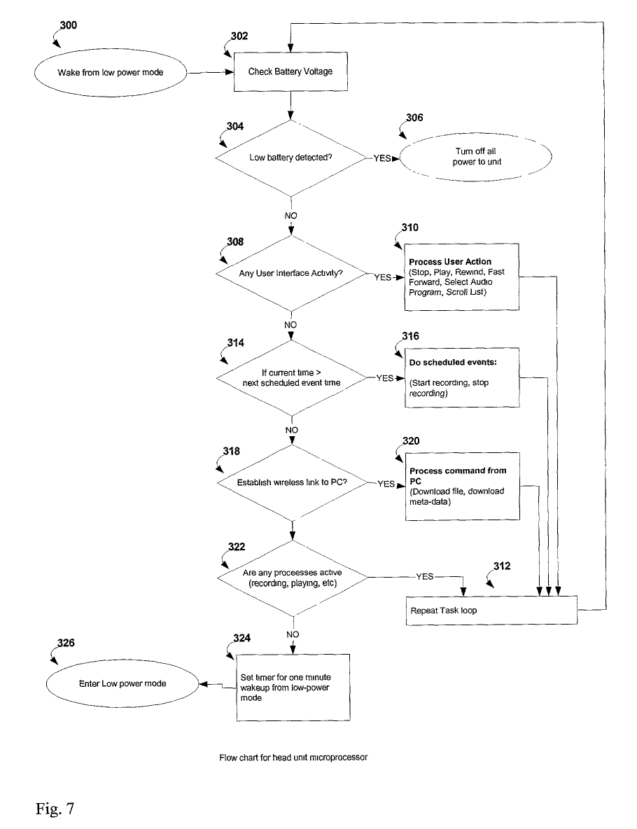

FIG. 7 shows the main task loop for the microprocessor 104 of the audio playback device 63 of the invention. As noted above, the microprocessor 104 is ideally kept in a sleep mode or low power mode when not in use. Accordingly, the microprocessor 104 must be awakened from such a mode at step 300 to perform any tasks. The microprocessor 104 then checks the voltage level of the battery 65 at step 302. If a low battery current is detected at step 304, then the audio playback device 63 is completely turned off at step 306 to avoid further draining of the battery 65. If the battery current is determined at step 304 to be sufficient, microprocessor 104 checks at step 308 for input from the user via user I/O interface 150. If input is detected, then the requested task is performed at step 310 and the task loop is repeated at step 312. Otherwise, the microprocessor 104 checks at step 314 if it is time to perform a scheduled event. If so, the scheduled event (e.g., recording an audio performance) is performed at step 316 and the task loop is repeated at step 312. Otherwise, the microprocessor 104 checks at step 318 to determine if it is time to establish a wireless link to the user's PC. If so, the file download process described with respect to FIG. 6 is performed at step 320 and the task loop is repeated at step 312. If no wireless link is to be established at step 318, then microprocessor 104 checks at step 322 to determine if any processes (e.g., recording, playback, etc.) are active. If so, the task loop is repeated at step 312. If no process is active, a wake-up timer is set at step 324 for a predetermined sleep time (e.g., one minute), and the microprocessor 104 is returned to the low power or sleep mode at step 326. The entire process will then be repeated when the microprocessor 104 wakes from the low power mode.

Although exemplary implementations of the invention have been described in detail above, those skilled in the art will readily appreciate that many additional modifications are possible in the exemplary embodiments without materially departing from the novel teachings and advantages of the invention. For example, those skilled in the art will appreciate that the techniques of the invention are not limited to use in a vehicle. Those skilled in the art will appreciate that the techniques of the invention also may be used to provide digital audio data to home stereo equipment. Also, the costs of the device may be minimized by using DRAM in place of conventional memory using the techniques described herein. In such an embodiment, the audio receiver may accept a CD or other digital audio storage device or accept digital audio data wirelessly from a nearby computer or via a cable or home data network. The digital audio data may then be stored in the DRAM for playback as desired. In this embodiment, the user interface for making selections may be either on the computer or on the audio playback device. Accordingly, these and all such modifications are intended to be included within the scope of this invention. The invention may be better defined by the following exemplary claims.

What is claimed is:

1. An audio system for use in a vehicle for the playback of audio data by a sound amplification system of the vehicle, the audio system comprising:
(a) a dynamic random access memory (DRAM) that stores the audio data for playback;
(b) an audio playback device that reads the audio data from the DRAM and converts it to a form which can be output to the vehicle's sound amplification system;
(c) an audio acquisition device that receives the audio data to be stored in the DRAM; and
(d) a power supply system between the vehicle's electrical system and the audio system, the power supply system supplying power to the audio system consistently including when the vehicle is not in use.

2. The audio system of claim 1, wherein said DRAM comprises a synchronous DRAM (SDRAM) and an SDRAM controller having a low-power self-refresh mode whereby the SDRAM may retain its contents but cannot be accessed by the audio playback device.

3. The audio system of claim 1, wherein the audio playback device comprises an integrated unit including a conventional vehicle radio, a digital audio playback device that records audio data to and reads audio data from said DRAM, and an audio amplifier that amplifies outputs of said vehicle radio and said audio playback device for output to the vehicle's sound amplification system.

4. The audio system of claim 1, wherein the audio playback device comprises a conventional vehicle audio system including a conventional vehicle radio and an audio amplifier and a physically separate add-on audio playback device that records audio data to and reads audio data from said DRAM and modulates the audio data onto a frequency recognizable by said vehicle radio for amplification by said audio amplifier and output to the vehicle's sound amplification system.

5. The audio system of claim 1, wherein said audio acquisition device comprises a radio receiver/demodulator that receives broadcast analog audio signals, converts the received audio signals into digital audio signals, and encodes the digital audio signals for storage in said DRAM.

6. The audio system of claim 1, wherein said audio acquisition device comprises a radio receiver that receives broadcast digital signals and stores the received broadcast digital signals in said DRAM.

7. The audio system of claim 1, wherein said audio acquisition device comprises a radio receiver that receives digital data transmitted wirelessly to said audio system from a nearby computer or media server and stores the received digital data in the DRAM.

8. The audio system of claim 1, wherein said audio acquisition device comprises a Compact Disc (CD) drive that reads audio data from an audio CD and stores the audio data in said DRAM.

9. The audio system of claim 1, wherein said power supply system includes a power supply switch and a low-voltage monitor that detects a power output of the vehicle's electrical system and controls said power supply switch to selectively minimize or remove power to said audio system to prevent excessive drain on the vehicle's electrical system.

10. An audio system for use in a vehicle for the playback of audio data by a sound amplification system of the vehicle, the audio system comprising:
(a) a nonvolatile digital storage device that stores the audio data for playback;
(b) an audio playback device that reads the audio data from the digital storage device and converts it to a form which can be output to the vehicle's sound amplification system;
(c) a first audio acquisition device that receives the audio data to be stored in the digital storage device, said first audio acquisition device including a radio receiver/demodulator that receives broadcast audio signals and stores the received audio signals in said digital storage device; and
(d) a second audio acquisition device comprises a radio receiver that receives audio data transmitted wirelessly to said audio system from a nearby computer or media server and stores the received audio data in the digital storage device.

11. The audio system of claim 10, wherein said digital storage device comprises a synchronous DRAM (SDRAM) and an SDRAM controller having a low-power self-refresh mode whereby the SDRAM may retain its contents but cannot be accessed by the audio playback device.

12. The audio system of claim 10, wherein the audio playback device comprises an integrated unit including a conventional vehicle radio, a digital audio playback device that reads said audio data from said digital storage device, and an audio amplifier that amplifies outputs of said vehicle radio and said audio playback device for output to the vehicle's sound amplification system.

13. The audio system of claim 10, wherein the audio playback device comprises a conventional vehicle audio system including a conventional vehicle radio and an audio amplifier and a physically separate add-on audio playback device that reads said audio data from said digital storage device and modulates the audio data onto a frequency recognizable by said vehicle radio for amplification by said audio amplifier and output to the vehicle's sound amplification system.

14. The audio system of claim 10, wherein said first audio acquisition device comprises a radio receiver that receives broadcast digital signals from a wireless Internet connection and stores the received broadcast digital signals in said digital storage device.

15. The audio system of claim 10, wherein said first audio acquisition device comprises a radio receiver that receives broadcast analog audio signals from a radio broadcast station, converts the received audio signals into digital audio signals, and encodes the digital audio signals for storage in said digital storage device.

16. The audio system of claim 10, wherein said second audio acquisition device comprises an IEEE 802.11 wireless receiver.

17. The audio system of claim 10, wherein said computer or media server stores a library of digital audio and includes a software interface that permits a user to select audio selections from said library for transmission to said audio system for storage in said digital storage device at predetermined times or at predetermined time intervals.

18. The audio system of claim 17, wherein said software interface permits a user to remotely select audio data for recording by said first audio acquisition device.

19. The audio system of claim 10, further comprising a power supply system between the vehicle's electrical system and the audio system, the power supply system supplying power to the audio system consistently including when the vehicle is not in use.

20. The audio system of claim 19, wherein said power supply system includes a power supply switch and a low-voltage monitor that detects a power output of the vehicle's electrical system and controls said power supply switch to selectively minimize or remove power to said audio system to prevent excessive drain on the vehicle's electrical system.

21. A method for providing audio playback of pre-recorded audio content in a vehicle over the vehicle's sound amplification system, comprising:
(a) a user selecting specific audio content that the user wants to listen to in the vehicle;
(b) establishing a wireless networking connection between an audio device that is mounted in the vehicle and a remote source of the specific audio content;
(c) transferring a copy of the specific audio content over the wireless connection from the remote source to the audio device;
(d) the audio device receiving the specific audio content and storing it in non-volatile memory; and.
(e) the user interacting with the audio device to cause it to play back said specific audio content.

22. The method of claim 21, comprising the additional steps of the user selecting and downloading audio content to said audio device from a library of digital audio at a predetermined time or at a predetermined time interval.

23. The method of claim 22, wherein said downloading step comprises the step of transmitting digital audio from a computer containing said library of digital audio to said audio device in a vehicle via a wireless short-range radio connection.

24. An audio system for use in a vehicle for the playback of audio data by a sound amplification system of the vehicle, the audio system comprising:
a non-volatile digital storage device that stores the audio data for playback;
an audio playback device that reads the audio data from the digital storage device and converts it to a form which can be output to the vehicle's sound amplification system;
a first audio acquisition device that receives the audio data to be stored in the digital storage device, said first audio acquisition device including a radio receiver/demodulator that receives broadcast audio signals and stores the received audio signals in said digital storage device; and
a second audio acquisition device comprising a Compact Disc (CD) reader.

25. An audio system for use in a vehicle for the playback of audio data by a sound amplification system of the vehicle, the audio system comprising:
a non-volatile digital storage device that stores the audio data for playback;
an audio playback device that reads the audio data from the digital storage device and converts it to a form which can be output to the vehicle's sound amplification system;
a first audio acquisition device comprising a Compact Disc (CD) reader; and
a second audio acquisition device comprising a radio receiver that receives audio data transmitted wirelessly to said audio system from a nearby computer or media server and stores the received audio data in the digital storage device.

26. An audio system for the playback of audio data by a sound amplification system, comprising:
(a) a dynamic random access memory (DRAM) that stores the audio data for playback;
(b) an audio playback device that reads the audio data from the DRAM and converts it to a form which can be output to the sound amplification system;
(c) an audio acquisition device that receives the audio data to be stored in the DRAM; and
(d) a power supply system supplying power to the DRAM consistently including when power is removed from the rest of the audio system.

27. The audio system of claim 26, wherein said audio acquisition device comprises a radio receiver that receives digital data transmitted wirelessly to said audio system from a nearby computer or media server and stores the received digital data in the DRAM.

28. The audio system of claim 27, wherein said computer or media server stores a library of digital audio and includes a software interface that permits a user to select audio selections from said library for transmission to said audio system for storage in said DRAM at predetermined times or at predetermined time intervals.
